(19) United States
(12) Patent Application Publication
(10) Pub. No.: US 2007/0230662 A1
(43) Pub. Date: Oct. 4, 2007

(54) Rotary anode X-ray tube device

(75) Inventors: Yoshifumi Imai, Otawara-shi (JP); Shin Saito, Otawara-shi (JP); Naoki Akahori, Otawara-shi (JP)

Correspondence Address: PILLSBURY WINTHROP SHAW PITTMAN, LLP, P.O. BOX 10500, MCLEAN, VA, 22102, US

(73) Assignees: KABUSHIKI KAISHA TOSHIBA, Tokyo (JP); Toshiba Electron Tubes & Devices Co., Ltd., Otawara-shi (JP)

(21) Appl. No.: 11/727,781

(22) Filed: Mar. 28, 2007

(30) Foreign Application Priority Data
Mar. 29, 2006 (JP) 2006-092027
Mar. 15, 2007 (JP) 2007-067156

(51) Int. Cl. H01J 35/00

(52) U.S. Cl. 378/130

(57) ABSTRACT

A rotary anode X-ray tube device includes an X-ray tube equipped with an X-ray output window from which an X-ray is to be outputted, a housing which accommodates the X-ray tube and is filled with a cooling liquid for cooling the X-ray tube, a circulation pump which circulates the cooling liquid filled in the housing, and a subsidiary ejection pipe which guides the cooling liquid circulated by means of the circulation pump to form a flow of the cooling liquid along the X-ray output window, at a position that corresponds to the X-ray output window.

### CROSS-REFERENCE TO RELATED APPLICATIONS

This application is based upon and claims the benefit of priority from prior Japanese Patent Application No. 2006-092027, filed Mar. 29, 2006; and No. 2007-067156, filed Mar. 15, 2007, the entire contents of both of which are incorporated herein by reference.

### BACKGROUND OF THE INVENTION

1. Field of the Invention

The present invention relates to a rotary anode X-ray tube device mounted on equipment such as an X-ray image diagnosing apparatus represented by an X-ray computerized tomographic imaging apparatus or a nondestructive inspection apparatus.

2. Description of the Related Art

Conventionally, it has been well known that a rotary anode X-ray tube is mounted on equipment such as an X-ray image diagnosing apparatus represented by an X-ray computerized tomographic imaging apparatus or a nondestructive inspection apparatus and is used as a source of generating X-rays. This rotary anode X-ray tube is accommodated in a housing filled with a cooling liquid, and is equipped with: an anode target for generating X-rays due to collision of electrons; an electron discharge source for discharging electrons toward the anode target; and a vacuum envelope for maintaining at least the anode target and the periphery of the electron discharge source at a predetermined degree of vacuum.

The electrons discharged from the electron discharge source are accelerated by means of a voltage applied between the anode target and the electron discharge source, and then, the accelerated electrons collide with a focal face of the anode target. The electrons having collided with the anode target are energy-converted on the anode target, and then, heat and X-rays are generated.

The generated X-rays are outputted through an X-ray output window engaged with the vacuum envelope and an X-ray transmission window engaged with the housing, and then, the outputted X-rays are used as materials for generating an X-ray image.

The generated heat is discharged in the cooling liquid filled in the housing. Therefore, the cooling liquid in the housing is circulated by means of a circulation pump installed outside the housing, and a cool cooling liquid is supplied to the periphery of the rotary anode X-ray tube.

As such a rotary anode X-ray tube device, there is disclosed a device for forming the flow of an insulation oil 38 toward an X-ray radiation window 84 by means of a nozzle 102 (reference should be made to Jpn. Pat. Appln. KOKAI Publication No. 2004-152680, for example). It is an object of the disclosure to improve cooling efficiency while eliminating stagnation of the insulation oil 38.

Note that, in a conventional rotary anode X-ray tube device, connection between the housing and the circulation pump is made after the cooling liquid is filled in the housing. Therefore, when the housing and the circulation pump are connected to each other, air bubbles may enter the housing.

The air bubbles having entered the housing move inside the housing together with the cooling liquid. However, if these air bubbles exist in the range of X-ray irradiation (passage), in other words, if the air bubbles exist in a gap between the X-ray output window of the vacuum envelope and the X-ray transmission window of the housing, non-uniformity occurs with the X-rays outputted from the rotary anode X-ray tube device. Therefore, if the rotary anode X-ray tube device in which air bubbles have entered the housing is mounted on an X-ray image diagnosing apparatus represented by an X-ray computerized tomographic imaging apparatus or a nondestructive inspection apparatus, a quality of an X-ray image generated may be lowered.

The present invention provides a rotary anode X-ray tube device that is capable of outputting X-rays with uniform intensity.

### BRIEF SUMMARY OF THE INVENTION

A rotary anode X-ray tube device in the present invention is configured as follows.

A rotary anode X-ray tube device comprises: an X-ray tube equipped with an X-ray output window from which an X-ray is to be outputted; a housing which accommodates the X-ray tube and is filled with a cooling liquid for cooling the X-ray tube; a circulation pump which circulates the cooling liquid filled in the housing; and guide means for guiding the cooling liquid circulated by means of the circulation pump to form a flow of the cooling liquid along the X-ray output window, at a position that corresponds to the X-ray output window.

A rotary anode X-ray tube device, mounted on a gantry of an X-ray computerized tomographic imaging apparatus and rotating at a high speed together with the gantry, comprises: an X-ray tube equipped with an X-ray output window from which an X-ray is to be outputted; a housing which accommodates the X-ray tube and is filled with a cooling liquid for cooling the X-ray tube; and diffusion means disposed in a gap between the X-ray tube and the housing, for diffusing a flow of a cooling liquid that flows into at a position that corresponds to the X-ray output window.

According to the present invention, X-rays with uniform intensity can be outputted.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view of a rotary anode X-ray tube device in a first embodiment of the present invention;

FIG. 2 is a sectional view-of the rotary anode X-ray tube device in the same embodiment;

FIG. 3 is a sectional view of a rotary anode X-ray tube device in a second embodiment of the present invention;

FIG. 4 is a sectional view of a rotary anode X-ray tube device in a third embodiment of the present invention;

FIG. 5 is a schematic view of an X-ray computerized tomographic imaging apparatus in a fourth embodiment of the present invention;

FIG. 6 is a sectional view of a rotary anode X-ray tube device in the same embodiment;

FIG. 7 is a sectional view of a rotary anode X-ray tube device in a fifth embodiment of the present invention;

FIG. 8 is a sectional view of a rotary anode X-ray tube device in a sixth embodiment of the present invention; and

FIG. 9 is a sectional view of a rotary anode X-ray tube device in a seventh embodiment of the present invention.

### DETAILED DESCRIPTION OF THE INVENTION

First to seventh embodiments will be described below with reference to the accompanying drawings.

### FIRST EMBODIMENT

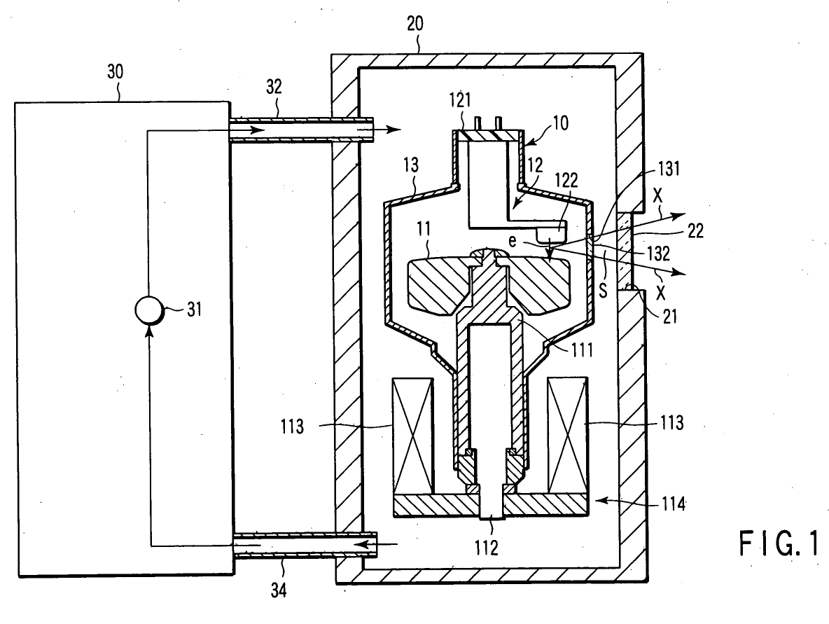

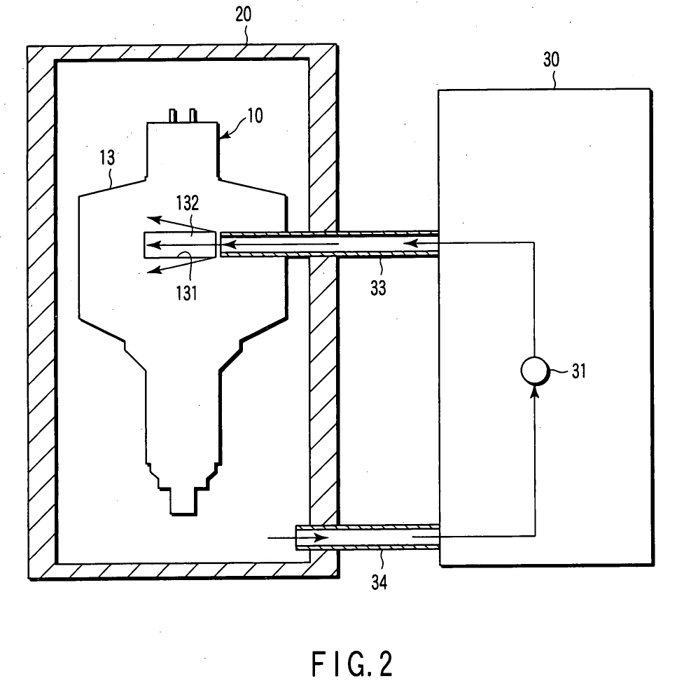

First, the first embodiment will be described in detail referring to FIGS. 1 and 2.

[Configuration of Rotary Anode X-ray Tube Device]

FIG. 1 is a sectional view of a rotary anode X-ray tube device in a first embodiment of the present invention; and FIG. 2 is a sectional view of the rotary anode X-ray tube device in the same embodiment.

As shown in FIG. 1, the rotary anode X-ray tube device in the present embodiment is mounted on equipment such as an X-ray image diagnosing apparatus represented by an X-ray computerized tomographic imaging apparatus or a nondestructive inspection apparatus. This X-ray tube device is composed of: an X-ray tube 10 for radiating X-rays; a housing 20 for housing the X-ray tube 10, the housing being filled with a cooling liquid for cooling the X-ray tube 10; and a circulation pump 30 connected to the housing 20, the circulation pump circulating the cooling liquid filled in the housing 20. As a cooling liquid, a non-oil based cooling liquid with a low electric conductivity consisting essentially of water, or alternatively, a well-known insulation oil is used.

The X-ray tube 10 is equipped with: an anode target 11 for generating X-rays “x” due to collision of electrons “e”; a cathode assembly body 12 disposed in opposite to the anode target 11 and radiating electrons “e” toward this anode target 11; and a vacuum envelope 13 for housing the anode target 11 and the cathode assembly body 12, and maintaining the periphery thereof at a predetermined degree of vacuum.

The anode target 11 is formed in a disk shape, and a center portion in a radial direction thereof is supported by means of a rotational body 111. This rotational body 111 is rotatably supported by means of a fixing shaft 112 and configures a motor 114 for rotating the anode target 11 together with a stator coil 113 arranged outside the vacuum envelope 13. In this manner, as long as the motor 114 rotates the anode target 11, the electrons “e” from the cathode assembly body 12 are not intensively irradiated at one site of the anode target 11 even if the X-ray tube 10 is used for a-long period of time. Thus, the anode target 11 does not enter an overheated state.

The cathode assembly body 12 is mounted on the vacuum envelope 13 via an insulation member 121 in order to promote electrical insulation from the vacuum envelope 13, and an emitter source (electron discharge source) 122 for discharging electrons “e” is disposed at a site that corresponds to the anode target 11. The insulation member 121 is made of alumina ceramics, for example.

The vacuum envelope 13 is formed of metal member or an insulation member such as glass, and an opening 131 is formed laterally of the anode target 11. This opening 131 is formed in an elongated shape in a radial direction of the anode target 11, and an X-ray output window 132 for outputting the X-rays radiated from the anode target 11 to the outside of the X-ray tube 10 is engaged inside the opening 131.

The housing 20 functions as a protective wall for preventing the leakage of X-rays and an opening 21 is formed at a position that corresponds to the X-ray output window 132 provided at the vacuum envelope 13 of the X-ray tube 10. This opening 21 is formed in the same shape as that of the opening 131 formed at the vacuum envelope 13, and an X-ray transmission window 22 for transmitting the X-rays radiated from the X-ray tube 10 to the outside of the housing 20 is engaged inside the opening 21.

A gap S such that a cooling liquid can flow exists between the X-ray output window,132 that is engaged in the vacuum envelope 13 of the X-ray tube 10 and the X-ray transmission window 22 that is engaged in the housing 20. The gaps S is very narrow, so that air bubbles are easily accumulated if the cooling liquid does not flow.

The circulation pump 30 is equipped with: a pump main body 31 for generating a pressure; a main ejection pipe 32 and a subsidiary ejection pipe (guide means) 33 connected to the pump main body 31 for ejecting a cooling liquid into the housing 20 under the pressure from the pump main body 31; and a suction pipe 34 connected to the pump main body 31 for suctioning the cooling liquid from the inside of the housing 20 under the pressure from the pump main body 31.

While two circulation pumps 30 exist in FIGS. 1 and 2, there actually exist only one circulation pump 30. However, no structural problem occurs even if there are two circulation pumps 30, the main ejection pipe 32 is connected to one of them, and the subsidiary ejection pipe 33 is connected to the other one.

The main ejection pipe 32 is connected to a side wall situated in opposite to the X-ray output window 132 of the housing 20, and entirely circulates the cooling liquid filled in the housing 20. Therefore, an ejection quantity of the cooling liquid from the main ejection pipe 32 is greater than that from the subsidiary ejection pipe 33.

The subsidiary ejection pipe 33 is connected to a side wall situated laterally of the X-ray output window 132 and the X-ray transmission window 22 along a longitudinal direction of the X-ray transmission window 22 and the X-ray output window 132. In this way, when a pump operation of the circulation pump 30 is started, the cooling liquid is ejected from the subsidiary ejection pipe 33 toward the gap S between the X-ray output window 132 and the X-ray transmission window 22, and then, the flow of the cooling liquid relative to the longitudinal direction of the X-ray output window 132 and the X-ray transmission window 22 is formed in the gap S between the X-ray output window 132 and the X-ray transmission window 22.

[Operation of Rotary Anode X-ray Tube]

First, electrons “e” are discharged from the emitter source 122 of the cathode assembly body 12.

The discharged electrons “e” are accelerated by means of a high voltage applied between the anode target 11 and the cathode assembly body 12, and then, the accelerated electrons collide with a focal face of the anode target 11. The electrons “e” having collided with the anode target 11 are converted into heat and X-rays. Part of the generated X-rays transmit the X-ray output window 132, a cooling liquid, and the X-ray transmission window 22 sequentially in this order, and are outputted to the outside of the housing 20. The heat generated at the anode target 11 due to collision of the electrons “e” is discharged to the outside of the rotary anode X-ray tube device through the cooling liquid filled in the periphery of the X-ray tube 10.

In addition, when use of the rotary anode X-ray tube device is started, the circulation pump 30 is started up. Then, the subsidiary ejection pipe 33 starts ejection of the cooling liquid, and then, forms the flow of the cooling liquid relative to the longitudinal direction of the X-ray output window 132 and the X-ray transmission window 22 in the gap S between the X-ray output window 132 and the X-ray transmission window 22.

In this manner, even if air bubbles enters the housing 20, these air bubbles do not stay in the gap S between the X-ray output window 132 and the X-ray transmission window 22. Thus, the X-rays radiated from the X-ray tube 10 do not transmit the air bubbles. Even if air bubbles stay in the gap S between the X-ray output window 132 and the X-ray transmission window 22 at a time point when the use of the rotary anode X-ray tube device is started, these air bubbles are flown immediately. Thus, the X-rays radiated from the X-ray tube 10 do not transmit the air bubbles.

The X-rays outputted from the rotary anode X-ray tube device are irradiated to a target, and the X-rays having transmitted the target are used as a material for generating an X-ray image.

Advantageous Effect According to the Present Embodiment

In the present embodiment, the subsidiary ejection pipe 33 connected to the circulation pump 30 is connected to a lateral position of the X-ray output window 132 and the X-ray transmission window 22, in the housing 20, and ejects a cooling liquid toward the gap S between the X-ray output window 132 and the X-ray transmission window 22.

As a result, the flow of the cooling liquid is forcibly formed in the gap S between the X-ray output window 132 and the X-ray transmission window 22. Therefore, even if air bubbles exist in the gap S between the X-ray output window 132 and the X-ray transmission window 22, these air bubbles do not stay in the gap S between the X-ray output window 132 and the X-ray transmission window 22.

As a result, the X-rays radiated from the X-ray output window 132 of the X-ray tube 10 are outputted from the X-ray transmission window 22 of the housing 20 to the outside of the rotary anode X-ray tube device without transmitting the air bubbles. Thus, the intensity of X-rays outputted becomes uniform in comparison with a conventional rotary anode X-ray tube. Therefore, when the rotary anode X-ray tube device in the present embodiment is used for an X-ray image diagnosing apparatus represented by an X-ray computerized tomographic imaging apparatus or for a nondestructive inspection apparatus, a very high quality X-ray image can be obtained.

In the present embodiment, the subsidiary ejection pipe 33 is connected, along the longitudinal direction of the X-ray output window 132 and the X-ray transmission window 22, to a side wall situated laterally of the X-ray output window 132 and the X-ray transmission window 22, in the housing 20.

Thus, the cooling liquid ejected from the subsidiary ejection pipe 33 flows along the X-ray output window 132 and the X-ray transmission window 22. Therefore, even if air bubbles exist in the gap S between the X-ray output window 132 and the X-ray transmission window 22, these air bubbles are efficiently eliminated.

In the present embodiment, the subsidiary ejection pipe 33 is not equipped with an element such as a nozzle that may cause a pressure loss. Thus, a burden on the circulation pump 30 is reduced.

In the present embodiment, the subsidiary ejection pipe 33 is provided apart from the main ejection pipe 32 for ejecting a cooling liquid into the housing 20, so that circulation of the cooling liquid filled in the housing 20 is sufficiently ensured.

### SECOND EMBODIMENT

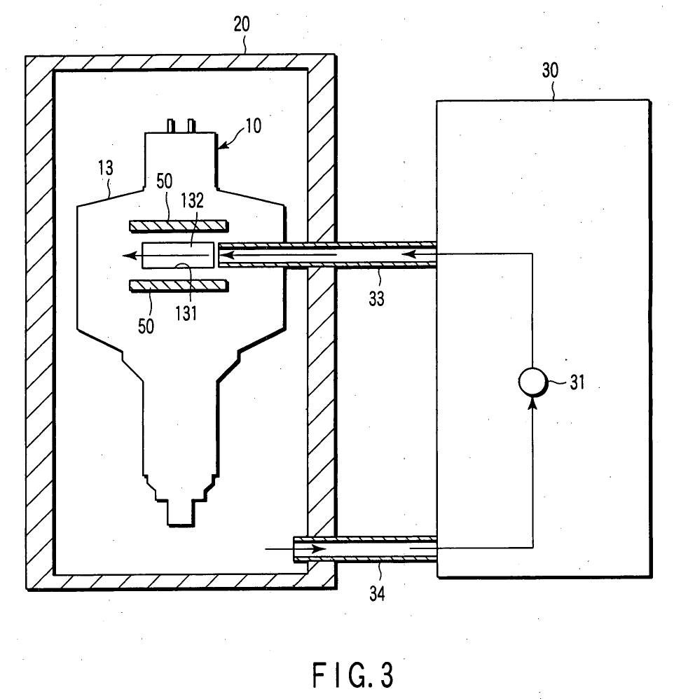

FIG. 3 is a sectional view of a rotary anode X-ray tube device in a second embodiment of the present invention.

As shown in FIG. 3, the rotary anode X-ray tube device in the present embodiment is different from that in the first embodiment in that two diffusion restriction plates 50 are added. These diffusion restriction plates 50 sandwich a gap area between an X-ray output window 132 and an X-ray transmission window 22 at both sides in a transverse direction of the X-ray output window 132 and the X-ray transmission window 22, in a gap S between an X-ray tube 10 and a housing 20.

In this manner, a cooling liquid ejected from a subsidiary ejection pipe 33 flows along the two diffusion restriction plates 50, whereby the cooling liquid does not diffuse in the transverse direction of the X-ray output window 132 and the X-ray transmission window 22. Therefore, the flow of the cooling liquid is efficiently formed in the gap S between the X-ray output window 132 and the X-ray transmission window 22. As a result, the ejection capacity of a circulation pump 30 can be lowered.

In the present embodiment, the two diffusion restriction plates 50 come into contact with both of a vacuum envelope 13 of the X-ray tube 10 and the housing 20. However, they may come into contact only the vacuum envelope 13 of the X-ray tube 10, or alternatively, may come into contact with only the housing 20, for example.

### THIRD EMBODIMENT

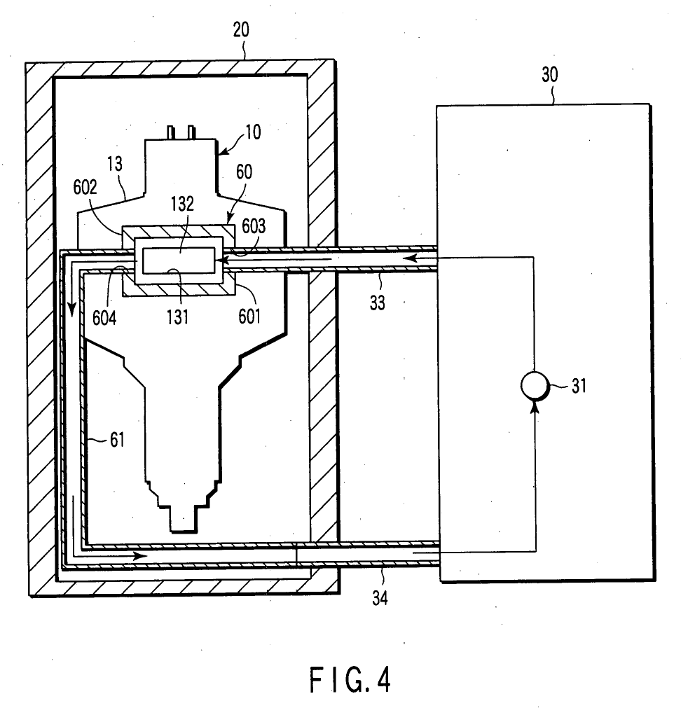

FIG. 4 is a sectional view of a rotary anode X-ray tube device in a third embodiment of the present invention.

As shown in FIG. 4, the rotary anode X-ray tube device in the present embodiment is different from that in the first embodiment in that a diffusion restriction frame 60 and a collection pipe 61 are added.

The diffusion restriction frame 60 is disposed in a gap S between an X-ray tube 10 and a housing 20 so as to surround a gap area between an X-ray output window 132 and an X-ray transmission window 22. Openings 603 and 604 are formed respectively at wall portions 601 and 602 disposed at both sides in a longitudinal direction of the X-ray output window 132 and the X-ray transmission window 22. A subsidiary ejection pipe 33 connected to a circulation pump 30 penetrates the housing 20 and is connected to the opening 603 of the diffusion restriction frame 60.

The collection pipe 61 is connected to the opening 604 of the diffusion restriction frame 60 and a suction pipe 34, and serves to guide a cooling liquid that outflows from the diffusion restriction frame 60 to the suction pipe 34.

In this way, if the cooling liquid is ejected from the subsidiary ejection pipe 33, the flow of the cooling liquid relative to a longitudinal direction of the X-ray output window 132 and the X-ray transmission window 22 is formed inside the diffusion restriction frame 60. In this manner, the cooling liquid flowing inside the diffusion restriction frame 60 is not influenced by the flow from the cooling liquid outside the diffusion restriction frame 60 by the presence of the diffusion restriction frame 60. Thus, even-if air bubbles enter a gap S between the X-ray output window 132 and the X-ray transmission window 22, these air bubbles are reliably eliminated.

In the present embodiment, the diffusion restriction frame 60 comes into contact with both of a vacuum envelope 13 of the X-ray tube 10 and the housing 20. However, it may come into contact with only the vacuum envelope 13 of the X-ray tube 10, or alternatively, may come into contact with only the housing 20, for example.

### FOURTH EMBODIMENT

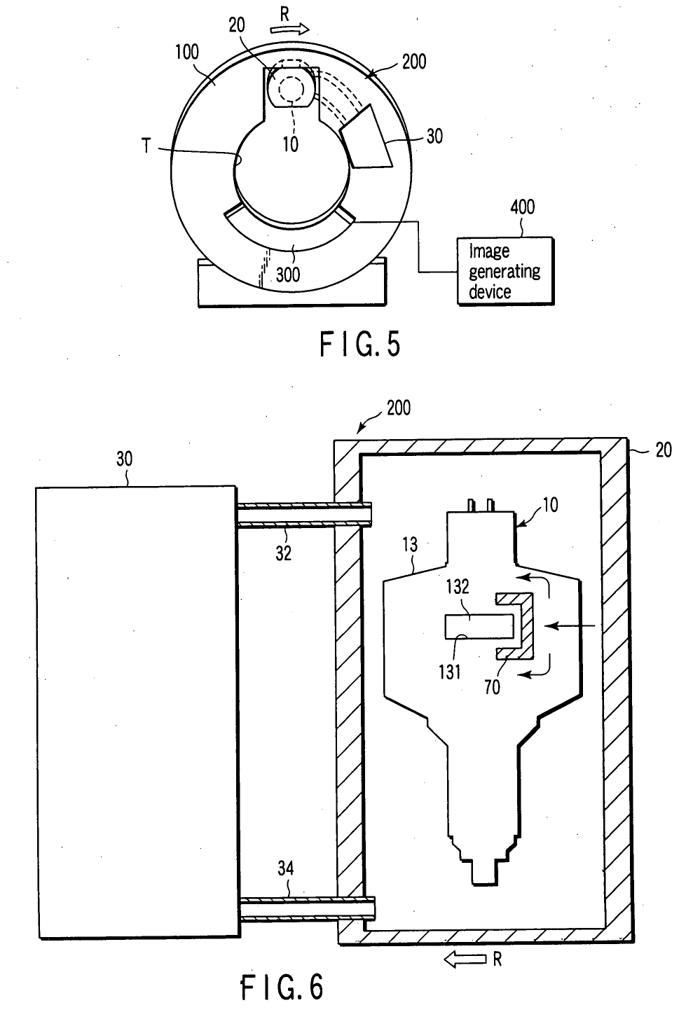

FIG. 5 is a schematic view of an X-ray computerized tomographic imaging apparatus in a fourth embodiment of the present invention; and FIG. 6 is. a sectional view of a rotary anode X-ray tube device 200 in the same embodiment. The arrow R in each of the figures indicates a rotational direction of a housing 20 and a circulation pump 30.

As shown in FIG. 5, the rotary anode X-ray tube device 200 in the present embodiment is different from that in the first embodiment in that a diffusion plate 70 is presumed to be added, and then, mounted on an X-ray computerized tomographic imaging apparatus.

First, a configuration of the X-ray computerized tomographic imaging apparatus will be briefly described here.

The X-ray computerized tomographic imaging apparatus is equipped with: a gantry 100 having formed therein a tunnel T for placing a target and rotating at a high speed around an axial core of this tunnel T; the rotary anode X-ray tube device 200 fixed to the gantry 100 and outputting X-rays; an X-ray detector 300 fixed to the gantry 100 for detecting intensity of the X-rays irradiated from the rotary anode X-ray tube device 200; and an image generating device 400 for generating an X-ray image based on the intensity of the X-rays detected by means of the X-ray detector 300. An X-ray tube 10 is disposed at a position shifted by about 180 degrees from the X-ray detector 300 with respect to a circumferential direction of the gantry 100, and an X-ray output window 132 is oriented to the X-ray detector 300.

The diffusion plate 70 is disposed in a gap S between the X-ray tube 10 and the housing 20 and at the upstream side in a rotational direction R of the gantry 100 relative to the X-ray output window 132 and an X-ray transmission window 22. When a cooling liquid filled in the housing 20 of the rotary anode X-ray tube device 200 flows in a direction identical to that of the gantry 100, together with rotation of the gantry 100, this cooling liquid collides with the diffusion plate 70 at the upstream side of the X-ray output window 132 and the X-ray transmission window 22; the resulting cooling liquid is divided into both sides in a transverse direction of the X-ray output window 132 and the X-ray transmission window 22; and turbulence is caused to occur at the periphery thereof.

In this manner, even if air bubbles enter the cooling liquid, these air bubbles are interfered with the diffusion plate 70 and does not flow into the gap S between the X-ray output window 132 and the X-ray transmission window 22. In addition, the housing 20 rotates at a high speed in R direction indicated-by the arrow during imaging, thus making it almost impossible for the air bubbles to travel around the side of the gap S. Even if the air bubbles flow into the gap S between the X-ray output window 132 and the X-ray transmission window 22, turbulence occurs in the gap between the X-ray output window 132 and the X-ray transmission window 22. Thus, the inflowing air bubbles are flown to the outside of the gap S immediately. In this manner, the X-rays having transmitted the X-ray output window 132 of the X-ray tube 10 are outputted to the outside of the rotary anode X-ray tube device 200 without transmitting the air bubbles. Thus, the intensity of the X-rays outputted becomes uniform in comparison with a conventional rotary anode X-ray tube device. Therefore, when the rotary anode X-ray tube device 200 in the present embodiment is used in the X-ray computerized tomographic imaging apparatus, a very high quality X-ray image can be obtained. In other words, in the present embodiment, the flow of the cooling liquid produced by means of rotation of the gantry 100 is utilized in order to eliminate air bubbles from the gap S between the X-ray output window 132 and the X-ray transmission window 22, while the flow of the cooling liquid produced by means of a pressure from the circulation pump 30 is not utilized.

### FIFTH EMBODIMENT

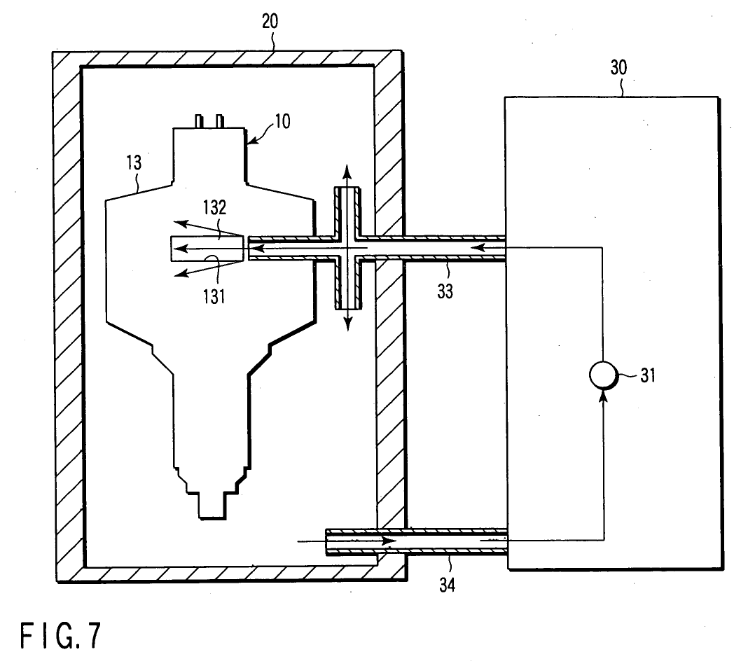

FIG. 7 is a sectional view of a rotary anode X-ray tube device in a fifth embodiment of the present invention. In FIG. 7, like functional elements in FIG. 2 are designated by like reference numerals. A detailed description thereof is omitted here.

As shown in FIG. 7, the rotary anode X-ray tube device in the present embodiment is different from that in the first embodiment in that branch pipes 33a and 33b are provided at a subsidiary ejection pipe 33. These branch pipes 33a and 33b are provided, whereby a cooling liquid is supplied to another portion of an X-ray output window 132.

In the present embodiment as well, an advantageous effect similar to that of the first embodiment described above can be attained.

### SIXTH EMBODIMENT

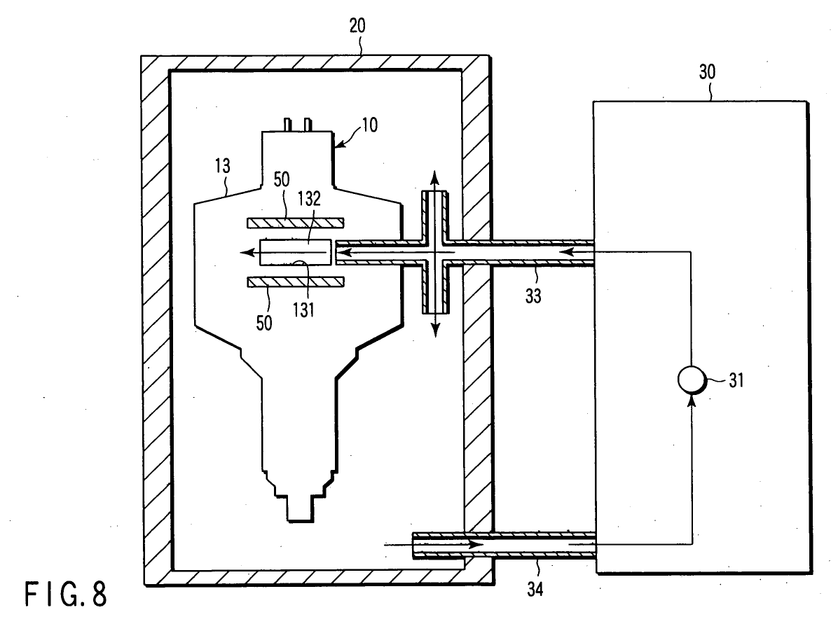

FIG. 8 is a sectional view of a rotary anode X-ray tube device in a sixth embodiment of the present invention. In FIG. 8, like functional elements in FIG. 3 are designated by like reference numerals. A detailed description thereof is omitted here.

As shown in FIG. 8, the rotary anode X-ray tube device in the present embodiment is different from that in the second embodiment in that branch pipes 33a and 33b are provided at a subsidiary ejection pipe 33. These branch pipes 33a and 33b are provided, whereby a cooling liquid is supplied to another portion of an X-ray output window 132.

In the present embodiment as well, an advantageous effect similar to that of the second embodiment described above can be attained.

### SEVENTH EMBODIMENT

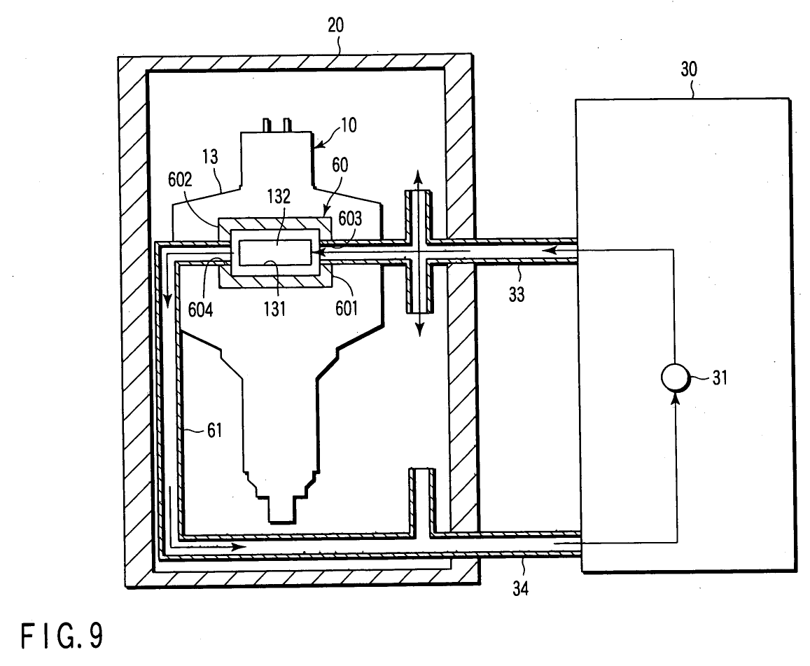

FIG. 9 is a sectional view of a rotary anode X-ray tube device in a seventh embodiment of the present invention. In FIG. 9, like functional elements in FIG. 4 are designated by like reference numerals. A detailed description thereof is omitted here.

As shown in FIG. 9, the rotary anode X-ray tube device in the present embodiment is different from that in the second embodiment in that branch pipes 33a and 33b are provided at a subsidiary ejection pipe 33 and a suction branch pipe 34a is provided at a suction pipe 34. These branch pipes 33a and 33b are provided, whereby a cooling liquid is supplied to another portion of an X-ray output window 132 and a cooling liquid of which an amount is equal to that of the cooling liquid ejected from the branch pipes 33a and 33b is collected by means of the suction branch pipe 34a.

In the present embodiment as well, an advantageous effect similar to that of the third embodiment described above can be attained.

The present invention is not limited to the embodiments described above. At the stage of carrying out the invention, the present invention can be embodied by modifying constituent elements without departing from the spirit of the invention. In addition, a variety of inventions can be formed by using a proper combination of a plurality of constituent elements disclosed in the embodiments. For example, some constituent elements may be eliminated from all the constituent elements disclosed in the embodiments. Further, constituent elements having encompassed the different embodiments may be combined with each other as required.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A rotary anode X-ray tube device, comprising:
an X-ray tube equipped with an X-ray output window from which an X-ray is to be outputted;
a housing which accommodates the X-ray tube and is filled with a cooling liquid for cooling the X-ray tube;
a circulation pump which circulates the cooling liquid filled in the housing; and
guide means for guiding the cooling liquid circulated by means of the circulation pump to form a flow of the cooling liquid along the X-ray output window, at a position that corresponds to the X-ray output window.

2. The rotary anode X-ray tube device according to claim 1, wherein the guide means forms the flow of the cooling liquid at the position that corresponds to the X-ray output window by utilizing an ejection force exerted by the circulation pump.

3. The rotary anode X-ray tube device according to claim 1, wherein the guide means forms the flow of the cooling liquid at the position that corresponds to the X-ray output window by utilizing a suction force exerted by the circulation pump.

4. The rotary anode X-ray tube device according to claim 1, wherein the guide means has dispersion means for dispersing the cooling liquid at a position different from the position that corresponds to the X-ray output window.

5. The rotary anode X-ray tube device according to claim 1, further comprising diffusion restriction means disposed in a gap between the X-ray tube and the housing, for restricting diffusion of the flow of the cooling liquid at the position that corresponds to the X-ray output window.

6. The rotary anode X-ray tube device according to claim 5, wherein the diffusion restriction means are at least two diffusion restriction plates which sandwich the position that corresponds to the X-ray output window.

7. The rotary anode X-ray tube device according to claim 5, wherein the diffusion restriction means is a diffusion restriction frame which surrounds the position that corresponds to the X-ray output window.

8. A rotary anode X-ray tube device mounted on a gantry of an X-ray computerized tomographic imaging apparatus and rotating at a high speed together with the gantry, the device comprising:
an X-ray tube equipped with an X-ray output window from which an X-ray is to be outputted;
a housing which accommodates the X-ray tube and is filled with a cooling liquid for cooling the X-ray tube; and
diffusion means disposed in a gap between the X-ray tube and the housing, for diffusing a flow of a cooling liquid that flows into at a position that corresponds to the X-ray-output window.

9. The rotary anode X-ray tube device according to claim 8, wherein the diffusion means is a diffusion plate which is disposed at an upstream side in a rotational direction of the gantry relative to the X-ray output window, and receives the cooling liquid that flows in the rotational direction of the gantry.

10. The rotary anode X-ray tube device according to claim 8, wherein the diffusion means generates turbulence at the position that corresponds to the X-ray output window.
